(19) United States
(12) Patent Application Publication
(10) Pub. No.: US 2025/0165908 A1
(43) Pub. Date: May 22, 2025

(54) METHODS FOR IDENTIFYING AN EVENT OF CONCERN FOR AN ITEM IN A SUPPLY CHAIN

(71) Applicant: Avery Dennison Retail Information Services LLC, Mentor, OH (US)

(72) Inventors: Michael GOLLER, Graz (AT); Renato JOVIC, Zagreb (HR); Mario KATUSIC, Graz (AT)

(21) Appl. No.: 18/839,461

(22) PCT Filed: Mar. 16, 2023
(86) PCT No.: PCT/US2023/064597

§ 371 Date: Aug. 19, 2024

Related U.S. Application Data
(60) Provisional application No. 63/320,321, filed on Mar. 16, 2022.

(51) Int. Cl. G06Q 10/0833; G06Q 10/0832; G06Q 10/087

(52) U.S. Cl. CPC G06Q 10/0833; G06Q 10/0832; G06Q 10/087

(57) ABSTRACT

In an embodiment, a processor-based method for identifying or determining a callout event sequence of a connected product at a point or site in a supply chain includes obtaining a real-time parameter of the connected product at a first location within the supply chain by receiving an output from an interrogation of a digital trigger that is attached to or incorporated into the connected product. The method further includes determining a comparison result by comparing the real-time parameter of the connected product with a target parameter using a condition. The method further includes, based on the comparison result, identifying a related callout. The method further includes, based on the callout, remedying the event by performing an automated action.

### CROSS-REFERENCE TO RELATED APPLICATION(S)

The present application claims the benefit of U.S. Provisional Patent Application No. 63/320,321 filed Mar. 16, 2022, which is incorporated herein by reference in its entirety.

### BACKGROUND

For some conventional systems and methods of sending items through a supply chain, tracking for various items may involve using itemized inventory lists to track how many of each item have been moved through a supply chain. Such conventional systems may allow for items to be forgotten, lost, or delayed during transit or movement through the supply chain, leading to inefficiency and waste. Accordingly, improvements over conventional systems may still be needed.

### BRIEF DESCRIPTION OF THE DRAWINGS

FIG. 1 is exemplary representations of a dashboard or hub providing global inventory trace information.

FIG. 2 is an exemplary representation of a dashboard or hub providing the fewest and greatest number of callouts.

FIG. 3 is an exemplary representation of a dashboard or hub providing dwell time callouts.

FIG. 4 is an exemplary representation of a hub or dashboard card showing inventory and callouts in warehouses and retail locations.

FIG. 5 is an exemplary representation of a hub or dashboard card showing inventory and callouts in warehouses and retail locations including callouts for a particular site or sites.

FIG. 6 is an exemplary representation of a hub or dashboard card showing inventory and callouts in warehouses and retail locations including callouts for a particular site or sites.

FIG. 7 is a flow chart showing the process of assigning a unique identification number to an item/article and associating data/information to that item/article.

FIG. 8 is a flow chart showing the process of comparing dwell time data.

FIG. 9 is a flow chart showing the process of comparing traversal data.

FIG. 10 is an exemplary representation of a hub or dashboard for purchase order management.

FIG. 11 is an exemplary representation of a hub or dashboard for customer experiences.

FIGS. 12 and 13 are exemplary representations of a hub or dashboard showing analytics of customer experiences or actions.

FIG. 14 is a block diagram of an exemplary computing system.

FIG. 15 is an illustrative diagram of a computer program product.

### SUMMARY

Methods and systems for identifying or determining an event of concern (e.g., a suspicious event or event sequence) for an item or article, such as goods in commerce, in a supply chain are described herein. In some embodiments, the item or article is a connected product. In some embodiments, the connected product is managed by a connected product platform or solution. In some embodiments, the connected product platform/solution is cloud-based.

In some embodiments, the event of concern includes a discrepancy, mismatch, or other disconnect between the supply chain data for an actual item or connected product and the same data for a reference item or connected product. For example, the connected product is a perishable food item which is allotted a maximum amount of time (dwell time) at a site in the supply chain. The dwell time for an actual product is compared to the dwell time for a reference product to determine if an anomaly is present.

In some embodiments, the supply chain is evaluated for a suspicious event sequence or anomaly in at least the dwell time of the connected product, traversal data, item status transition, or combinations thereof.

In some embodiments, the connected product can contain one or more digital triggers known in the art. Exemplary digital triggers include, but are not limited to, RFID (e.g., HF, UHF) tags, NFC, QR codes, bar codes, digital watermarks, Bluetooth beacons, etc. In some embodiments, the digital trigger and/or connected product contains a means for identifying the geographical location of the connected product. The digital trigger can be read or interrogated using any techniques/devices known in the art, including hand held devices, on-premises device, such as tunnels, gates, etc., smart carts, smart shelves, smart totes, pallet readers, etc. The reader/interrogating device can transmit the connected product data to an on-site data or transmit it to the cloud, either directly or via an API or other application.

The methods and systems described herein can also be used to manage purchase orders, evaluate/confirm sustainability scores, consumer experience/analytics, etc.

### DETAILED DESCRIPTION

### I. Definitions

“Anomaly” may refer to one or more discrepancies or mismatches between one or more item parameters and the same one or more reference item parameters.

“Connected product” may refer to a physical or other item, such as goods in commerce or raw or starting materials, that has attached or adhered thereto, or incorporated into, a digital trigger. Connected Products may refer to software, audio files, images, posters, or other items. Such items may be offered for sale or for licensing.

“Connected product cloud” may refer to a cloud-based platform which manages connected products.

“Digital trigger(s)” may refer to one or more sensors or devices that read, are read, adapt, and/or react to an environment in which it is used. Some examples of Digital Triggers may include one or more of QR codes, bar codes, NFC tags, RFID tags, digital watermarks, or other detectable features that may be used to identify a product or to cause an interaction, such as between a user and software, or between a first internet connected device and a second internet connected device. Additional information is provided below.

“Interrogating a digital trigger” may refer to exposing the digital trigger to a means for retrieving information from the trigger, e.g., radio signals and radio frequency identification tags. In some embodiments, interrogating a digital trigger may involve providing a condition intended to power a digital trigger or cause a digital trigger to respond.

“Item parameters” may refer to one or more properties, characteristics, criteria, details, etc. for an item at a site or a point in the supply chain.

“Intervention” may refer to one or more actions. For example, the actions may be taken to reduce, eliminate, or prohibit an anomaly, in some embodiments. In other embodiments, the actions may be taken to cause, encourage, increase, or otherwise affect an anomaly or other event.

“Point in the supply chain” may refer to a non-brick-and-mortar location in a supply chain, such as mode of transportation (e.g., truck, plane, ship).

“Reference item parameters” may refer to one or more properties, characteristics, criteria, details, etc., for a reference item at a point or site in the supply chain.

“Site in the supply chain” may refer to a brick-and-mortar location in the supply chain, such as a manufacturing site (e.g., factory), packing house, distribution center, warehouse, retail location, store, etc.

### II. Methods of Identifying or Determining a Suspicious Event Sequence

Methods for identifying a suspicious event sequence (e.g., one or more suspicious or incorrect events) or an anomaly of an item, such as an item of commerce or a raw or starting material(s), in a supply chain are described herein.

### A. Connected Products

In some embodiments, the item that is evaluated for a suspicious event sequence or anomaly is a connected product. In some embodiments, the digital trigger can be any digital trigger known in the art. Exemplary digital triggers include, but are not limited to, radio frequency identification (RFID) tag or label, a QR code, a bar code, a digital water mark, NFC, machine readable code, vision system, Bluetooth Low Energy (BLE) beacons, or other digital identification (ID) systems. In some embodiments, the digital trigger is one that is able to be serialized, i.e., encoded with a unique identification number.

### 1. RFID Tags/Labels

Radio Frequency item level sensors, also referred to as RFID tags, are wireless devices with various amounts of memory, typically an EPC memory space of 96-128 bits, a TID memory space of 48-96 bits, and optional features such as user memories described in GS1. These sensors have a unique ID, respond to RF energy and broadcast the presence of particular items to which they are attached. There are several factors that influence the range and readability of RFID item level sensor and antenna (inlay) including size, power and frequency.

A typical RFID device generally includes an antenna for wirelessly transmitting and/or receiving RF signals and analog and/or digital electronics operatively connected thereto. So called active or semi-passive RFID devices may also include a battery or other suitable power source. Commonly, the electronics are implemented via an integrated circuit (IC) or microchip or other suitable electronic circuit and may include, e.g., communications electronics, data memory, control logic, etc. In operation, the IC or microchip functions to store and/or process information, modulate and/or demodulate RF signals, as well as optionally performing other specialized functions. In general, RFID devices can typical retain and communicate enough information to uniquely identify individuals, packages, inventory and/or other like objects, e.g., to which the RFID device is affixed.

Commonly, an RFID reader or base station is used to wirelessly obtain data or information (e.g., such as an identification code) communicated from an RFID device. Typically, an RFID device is configured to store, emit, or otherwise exhibit an identification code or other identifier(s). The manner in which the RFID reader interacts and/or communicates with the RFID device generally depends on the type of RFID device. A given RFID device is typically categorized as a passive device, an active device, a semi-passive device (also known as a battery-assisted or semi-active device) or a beacon type RFID device (which is generally considered as a sub-category of active devices). Passive RFID devices generally use no internal power source, and as such, they are passive devices which are only active when an RFID reader is nearby to power the RFID device, e.g., via wireless illumination of the RFID device with an RF signal and/or electromagnetic energy from the RFID reader. Conversely, semi-passive and active RFID devices are provided with their own power source (e.g., such as a small battery). To communicate, conventional RFID devices (other than so called beacon types) respond to queries or interrogations received from RFID readers. The response is typically achieved by backscattering, load modulation and/or other like techniques that are used to manipulate the RFID reader's field. Commonly, backscatter is used in far-field applications (i.e., where the distance between the RFID device and reader is greater than approximately a few wavelengths), and alternately, load modulation is used in near-field applications (i.e., where the distance between the RFID device and reader is within approximately a few wavelengths).

Passive RFID devices typically signal or communicate their respective data or information by backscattering a carrier wave from an RFID reader. That is, in the case of conventional passive RFID devices, in order to retrieve information therefrom, the RFID reader typically sends an excitation signal to the RFID device. The excitation signal energizes the RFID device which transmits the information stored therein back to the RFID reader. In turn, the RFID reader receives and decodes the information from the RFID device.

As previously noted, passive RFID devices commonly have no internal power supply. Rather, power for operation of a passive RFID device is provided by the energy in the incoming RF signal received by the RFID device from the RFID reader. Generally, a small electrical current induced in the antenna of the RFID device by the incoming RF signal provides sufficient power for the IC or microchip in the RFID device to power up and transmit a response. This means that the antenna generally has to be designed both to collect power from the incoming signal and also to transmit the outbound backscatter signal.

Passive RFID devices have the advantage of simplicity and long life (e.g., having no battery to go dead). Nevertheless, their performance may be limited. For example, passive RFID devices generally have a more limited range as compared to active RFID devices.

Active RFID devices, as opposed to passive ones, are generally provisioned with their own transmitter and a power source (e.g., a battery, photovoltaic cell, etc.). In essence, an active RFID device employs the self-powered transmitter to broadcast a signal which communicates the information stored on the IC or microchip in the RFID device. Commonly, an active RFID device will also use the power source to power the IC or microchip employed therein.

Generally, there are two kinds of active RFID devices-one can be considered as a transponder type of active RFID device and the other as a beacon type of active RFID device. A significant difference is that active transponder type RFID devices are only woken up when they receive a signal from an RFID reader. The transponder type RFID device, in response to the inquiry signal from the RFID reader, then broadcasts its information to the reader. As can be appreciated, this type of active RFID device conserves battery life by having the device broadcast its signal only when it is within range of a reader. Conversely, beacon type RFID devices transmit their identification code and/or other data or information autonomously (e.g., at defined intervals or periodically or otherwise) and do not respond to a specific interrogation from a reader.

Generally, active RFID devices, due to their on-board power supply, may transmit at higher power levels (e.g., as compared to passive devices), allowing them to be more robust in various operating environments. However, the battery or other on-board power supply can tend to cause active RFID devices to be relatively larger and/or more expensive to manufacture (e.g., as compared to passive devices). Additionally, as compared to passive RFID devices, active RFID devices have a potentially more limited shelf life—i.e., due to the limited lifespan of the battery. Nevertheless, the self-supported power supply commonly permits active RFID devices to include generally larger memories as compared to passive devices, and in some instances the on-board power source also allows the active device to include additional functionality, e.g., such as obtaining and/or storing environmental data from a suitable sensor.

Semi-passive RFID devices are similar to active devices in that they are typically provisioned with their own power source, but the battery commonly only powers the IC or microchip and does not provide power for signal broadcasting. Rather, like passive RFID devices, the response from the semi-passive RFID device is usually powered by means of backscattering the RF energy received from the RFID reader, i.e., the energy is reflected back to the reader as with passive devices. In a semi-passive RFID device, the battery also commonly serves as a power source for data storage.

A conventional RFID device will often operate in one of a variety of frequency ranges including, e.g., a low frequency (LF) range (i.e., from approximately 30 kHz to approximately 300 kHz), a high frequency (HF) range (i.e., from approximately 3 MHz to approximately 30 MHz) and an ultra-high frequency (UHF) range (i.e., from approximately 300 MHz to approximately 3 GHz). A passive device will commonly operate in any one of the aforementioned frequency ranges. In particular, for passive devices: LF systems commonly operate at around 124 kHz, 125 kHz or 135 kHz; HF systems commonly operate at around 13.56 MHz; and, UHF systems commonly use a band anywhere from 860 MHz to 960 MHz. Alternately, some passive device systems also use 2.45 GHz and other areas of the radio spectrum. Active RFID devices typically operate at around 455 MHz, 2.45 GHz, or 5.8 GHz. Often, semi-passive devices use a frequency around 2.4 GHz.

The read range of an RFID device (i.e., the range at which the RFID reader can communicate with the RFID device) is generally determined by many factors, e.g., the type of device (i.e., active, passive, etc.). In some embodiments, passive LF RFID devices (also referred to as LFID or LowFID devices) can usually be read from within approximately 12 inches (0.33 meters); passive HF RFID devices (also referred to as HFID or HighFID devices) can usually be read from up to approximately 3 feet (1 meter); and passive UHF RFID devices (also referred to as UHFID devices) can be typically read from approximately 10 feet (3.05 meters) or more. However, the distances above are exemplary and the distances may vary (e.g., longer or shorter) depending on the characteristics listed above. One important factor influencing the read range for passive RFID devices is the method used to transmit data from the device to the reader, i.e., the coupling mode between the device and the reader—which can typically be either inductive coupling or radiative/propagation coupling. Passive LFID devices and passive HFID devices commonly use inductive coupling between the device and the reader, whereas passive UHFID devices commonly use radiative or propagation coupling between the device and the reader.

In inductive coupling applications (e.g., as are conventionally used by passive LFID and HFID devices), the device and reader are typically each provisioned with a coil antenna that together form an electromagnetic field there between. In inductive coupling applications, the device draws power from the field, uses the power to run the circuitry on the device's IC or microchip and then changes the electric load on the device antenna. Consequently, the reader antenna senses the change or changes in the electromagnetic field and converts these changes into data that is understood by the reader or adjunct computer. Because the coil in the device antenna and the coil in the reader antenna have to form an electromagnetic field there between in order to complete the inductive coupling between the device and the reader, the device often has to be fairly close to the reader antenna, which therefore tends to limit the read range of these systems.

Alternately, in radiative or propagation coupling applications (e.g., as are conventionally used by passive UHFID devices), rather than forming an electromagnetic field between the respective antennas of the reader and device, the reader emits electromagnetic energy which illuminates the device. In turn, the device gathers the energy from the reader via its antenna, and the device's IC or microchip uses the gathered energy to change the load on the device antenna and reflect back an altered signal, i.e., backscatter. Commonly, UHFID devices can communicate data in a variety of different ways, e.g., they can increase the amplitude of the reflected wave sent back to the reader (i.e., amplitude shift keying), shift the reflected wave so it is out of phase received wave (i.e., phase shift keying) or change the frequency of the reflected wave (i.e., frequency shift keying). In any event, the reader picks up the backscattered signal and converts the altered wave into data that is understood by the reader or adjunct computer.

The antenna employed in an RFID device is also commonly affected by numerous factor, e.g., the intended application, the type of device (i.e., active, passive, semi-active, etc.), the desired read range, the device-to-reader coupling mode, the frequency of operation of the device, etc. For example, insomuch as passive LFID devices are normally inductively coupled with the reader, and because the voltage induced in the device antenna is proportional to the operating frequency of the device, passive LFID devices are typically provisioned with a coil antenna having many turns in order to produce enough voltage to operate the device's IC or microchip. Comparatively, a conventional HFID passive device will often be provisioned with an antenna which is a planar spiral (e.g., with 5 to 7 turns over a credit-card-sized form factor), which can usually provide read ranges on the order of tens of centimeters. Commonly, HFID antenna coils can be less costly to produce (e.g., compared to LFID antenna coils), since they can be made using techniques relatively less expensive than wire winding, e.g., lithography or the like. UHFID passive devices are usually radiatively and/or propagationally coupled with the reader antenna and consequently can often employ conventional dipole-like antennas.

### 2. NFC

Near field communication, abbreviated NFC, is a form of contactless communication between mobile devices, such as smartphones or tablets, that utilizes electromagnetic radio fields rather than radio transmissions (e.g., Bluetooth, WiFi). NFC is an offshoot of RFID design for use by device and objects that are in close proximity to each other. Three types of NFC technology are currently in use: Type A, Type B, and FeliCa. The technology behind NFC allows a device, known as a reader, interrogator, or active device, to create a radio frequency current that communicates with another NFC compatible device or a small NFC tag holding the information the reader wants. Passive devices, such as the NFC tags, store information and communicate with the reader but do not actively read other devices. Peer-to-peer communication through two active devices is also a possibility with NFC. This allows both devices to send and receive information.

### 3. QR Codes

Quick Response (QR) codes are a type of matrix barcode (2-D barcode) which is machine-readable. QR codes often contain data for a locator, identifier, or tracker that points to a website or application. A QR code uses four standardized encoding modes (numeric, alphanumeric, byte/binary, and kanji) to store data efficiently; extensions may also be used. A QR code is detected by a 2-dimensional digital image sensor and then digitally analyzed by a programmed processor. The processor locates the three distinctive squares at the corners of the QR code image, using a smaller square (or multiple squares) near the fourth corner to normalize the image for size, orientation, and angle of viewing. The small dots throughout the QR code are then converted to binary numbers and validated with an error-correcting algorithm.

The amount of data that can be stored in the QR code symbol depends on the datatype (mode, or input character set), version (1, . . . , 40, indicating the overall dimensions of the symbol, i.e. 4×version number+17 dots on each side), and error correction level. The maximum storage capacities occur for version 40 and error correction level L (low), denoted by 40−L.

### 4. Digital Triggers for Plastic Packaging

In some embodiments, the one or more digital triggers are designed to be incorporated into plastic packaging. In some embodiments, the plastic packaging is used to package perishable food products, such as fresh cut fruits and/or vegetables, proteins, etc. Suitable sensors are available in commercially from Avery Dennison. In some embodiments, the RFID sensor placement on the packaging is such that the product inside the package does not overlap the RFID inlay area by more than 20% when the product is at rest on a shelf. In some embodiments, the RFID sensor may be a low profile inlay to reduce coverage area.

### 5. Low Profile Sensors

In some embodiments, the one or more digital triggers are designed as low profile item level sensors for difficult to read materials. In some embodiments, these sensors are used on packaged goods, such as food products. Suitable sensors are available in commercially from Avery Dennison. In some embodiments, the sensors can be mounted flush, with a spacer or lifted along its length to form a low profile flag tag. In some embodiments, the tag contains a built-in structure that separates the dielectric qualities of the product and the inlay. In some embodiments, the low profile inlay size is used to reduce coverage area.

### 6. Microwave-Safe Inlays

In some embodiments, the digital trigger is incorporated into a microwave-safe sensor. Microwave-safe sensors/inlays are described in WO2018/125977, WO2019/204694, WO2019/204698, WO2019/204704, WO2020/006202, WO2020/006219, WO2021/138237 and WO2021/134066, which are incorporated herein by reference.

In some embodiments, the microwave-safe sensor is a microwave-safe RFID tag that includes an antenna defining a gap and configured to operate at a first frequency. An RFID chip and an antenna electrically coupled to the antenna across the gap. A shielding structure is electrically coupled to the antenna across the gap and overlays the RFID chip. The shielding structure includes a shield conductor and a shield dielectric at least partially positioned between the shield conductor and the RFID chip. The shielding structure is configured to limit the voltage across the gap when the antenna is exposed to a second frequency that is greater than the first frequency.

In some embodiments, the antenna is, or contains, an antenna with a sheet resistance in the range of approximately 100 ohms to approximately 230 ohms. In another aspect, an RFID tag includes an RFID chip and an antenna electrically coupled to the RFID chip. The antenna is, or contains, a conductor formed of a base material and a second material with different coefficients of thermal expansion configured to cause the antenna to fracture into multiple pieces upon being subjected to heating.

In some embodiments, the microwave-safe RFID tag includes a substrate having opposing first and second surfaces. An antenna is secured to the first surface, defines a gap, and is configured to operate at a first frequency. An RFID chip is electrically coupled to the antenna across the gap. A shielding structure is secured to the second surface of the substrate, with at least a portion of the shielding structure being in substantial alignment with the gap. The shielding structure is configured to limit the voltage across the gap when the antenna is exposed to a second frequency that is greater than the first frequency.

In some embodiments, the antenna of the RFID tag is no larger than 40 mm in the maximum dimension. In some embodiments, a center of the shielding structure is substantially aligned with the RFID chip. In some embodiments, the shielding structure is larger than the gap. In some embodiments, the shielding structure is electrically coupled to the antenna through the substrate. In some embodiments, the RFID tag further includes first and second conductive bridges that extend between the antenna and the shielding structure through the substrate so that the first and second conductive bridges are associated with the antenna at opposing sides of the gap. In some embodiments, the first and second conductive bridges are substantially identical. In some embodiments, the first and second conductive bridges are substantially equally spaced from the gap. In some embodiments, each of the first and second conductive bridges is positioned closer to an associated edge of the shielding structure than to the gap. In some embodiments, each of the first and second conductive bridges comprises an electro-chemically formed via. In some embodiments, each of the first and second conductive bridges comprise a crimp. In some embodiments, each of the first and second conductive bridges comprise conductive ink(s) received by a respective hole defined in the substrate.

In some embodiments, the microwave tolerant RFID tag device can be secured to an item to be placed in a microwave field, such as food item, to be thawed, heated, reheated or cooked in a microwave oven. The RFID tag device contains at least one antenna designed to operate at one or more frequencies, and an RFID chip carrying data related to the product to which it is attached and/or the microwave process (e.g., cooking) that the microwave oven is required to perform. In some embodiments, the antenna of the RFID tag device is designed to prevent a destructive arc when placed in a high-level 2.45 GHz field, and minimizes heating of the RFID tag itself during the microwave process.

In other embodiments, an RFID reader system is coupled into a microwave oven cavity to be able to read the RFID tag data before the high-level 2.45 GHz field is applied, as the high-field is likely to destroy the RFID tag device. The RFID reader system may operate at 2.45 GHz and share or be co-located with the oven emitter, or operate at a separate frequency such as UHF in the range of 900 MHz to 930 MHz, or can operate at both frequencies. The RFID reader system then interfaces with the oven controller to authorize and/or control the cooking process of the tagged food item.

In some embodiments, the microwave safe RFID tag preferably contains a split ring (or shield) conductor formed on one side of a dielectric, a coil antenna conductor formed on an opposite side of the dielectric, and a RFID chip. The split ring conductor is separated from the coil antenna conductor by a dielectric. Further, the split ring conductor covers the majority of the coil antenna conductor, such that the split ring conductor capacitively couples to the coil antenna conductor via the dielectric. Additionally, the split ring conductor contains a gap which allows the microwave current to flow through the coil antenna conductor, yet no part of the coil antenna conductor in the gap interacts with the microwave current, which prevents arcing.

In other embodiments, the microwave safe RFID tag device contains a second split ring conductor which is rotated opposite of the first split ring conductor such that the gaps of the conductors do not align and current does not flow in the gaps. The coil antenna conductor is then positioned between the first and the second split ring conductors and capacitively couples to the conductors, effectively shorting the coil antenna conductor and the first and the second split ring conductors to prevent arcing and excessive current flow along the coil antenna conductor.

In other embodiments, the microwave-safe RFID inlay contains a pair of dipole arms extending from a tuning loop, wherein each of said dipole arms terminates in a load end. The conductive structure is further configured to have a metal mass that is less than a standard detection threshold of a metal detector that is used to scan food product items and their packaging. Additionally, the conductive structure has an area large enough to achieve a required or desired performance, but still below the typical standard detection threshold associated with scanning a food item or packaging for a foreign metal object of approximately a 1 mm diameter metal sphere. The conductive structure may be manufactured by printing a conductive ink, or by cutting a metal foil. A thickness of the overall conductive structure is then reduced to no less than a skin depth calculated for the respective conductive structure material and frequency. Portions of each load end may be hollowed out so that areas of the conductive structure having a lower current flow are removed with minimal impact on overall RFID performance, while also achieving a conductive structure with a mass below the detection threshold of the metal detector.

In other embodiments, packaging for a microwavable food item is provided. The packaging includes a first package member configured to be microwaved and a second package member associated with the first member, with the second package member being configured to be dissociated from the first package member prior to microwaving the first package member. The packaging also includes an RFID tag containing a reactive strap and a far-field antenna. The reactive strap is associated with the first package member, while the far-field antenna is associated with the second package member and is separate from the reactive strap. The reactive strap is configured to be coupled to the far-field antenna when the second package member is associated with the first package member and to be decoupled from the far-field antenna when the second package member is dissociated from the first package member. The RFID tag is capable of far-field communication when the reactive strap is coupled to the far-field antenna, while the reactive strap is capable of only near-field communication when it is decoupled from the far-field antenna.

In some embodiments, the microwave-safe RFID sensor is Wavesafe™, available from Avery Dennison. Wavesafe™ is a microwave-safe UHF RFID solution developed by Avery Dennison in 2017 and introduced to the market in 2019, for item-level tagging of fresh and frozen perishable packaged food products ensuring safety compliance. Wavesafe™ is designed to prevent arcing or heat build-up during microwaving while still delivering highly accurate read rates for time tracking.

Commercially available sensors include AD251, available from Avery Dennison. In some embodiments, the microwave-safe inlay is used for meats and seafood, including those packaged in/with foam trays. In some embodiments, the microwave-safe inlay is compliant with TÜV Rheinland® T-Mark certification standards. In some embodiments, the RFID sensor is placed on the outer side of the foam tray to ensure separation from the item.

### 7. Flagtags

In some embodiments, the sensor is, or contains, a flagtag. A flagtag is a label or tag containing a digital trigger, such as an RFID inlay, such that a portion of the tag or label can be offset from the rest of the tag or label. This can be helpful in reducing or eliminating interference between the item to which the tag or label is attached and the digital trigger (e.g., metallic item or packaging and an RFID metallic antenna. A variety of flagtag constructions are known in the art. In some embodiments, the construction has a fold to create the offset. An example is the Midas Flagtag® available from Avery Dennison. However, other flagtag constructions can be used.

### B. Interrogation of Digital Triggers

The digital triggers attached to, adhered to, or incorporated into the connected product can be interrogated or read using any method and/or device known in the art for interrogating or reading a particular digital trigger. For example, if the digital trigger is an RFID tag, the RFID can be interrogated or read by an RFID reader. The RFID reader can be a hand held device, such as a smart phone, tablet, or other hand held device or a macro-device, such as a tunnel scanner/reader, gate reader, overhead RFID reader, or shelf readers (e.g., smart shelves). Such equipment may be referred to as readers or hardware. Software can be incorporated into the hardware as needed to operate the hardware and analyze the data stored in the trigger. The reader can send data to an on-site server which can then send the information on to the connected product platform or the reader can send the information directly to the platform.

### 1. Local Read Points

In some embodiments, the digital triggers are interrogated or read by a combination of a local read point and a wide area read point.

In some embodiments, local-read points are or contain shelf level or pallet level reading devices that monitor the presence and the timestamp of last seen data from a given space. In some embodiments, the local read points are fully functional packaged units for ease of use, aesthetics, adaptability to existing fixtures, reducing or eliminating on-premises hardware requirements, and reducing cabling. In some embodiments, the devices publish unique item ID, time stamp, location, and type of event trigger to a defined destination. In some embodiments, event based data is sent directly from the reader with no on-premises server.

In some embodiments, the local read device is a phased array antenna grid. Phased array antenna grids provide a controllable read zone segment by cycling through signals that are transverse in phase. The result is a controlled and confined read zone that can be digitally progressed across a surface. A plurality of alternating phased elements create a grid section allowing for x-axis location recognition.

In some embodiments, the local read device is a smart shelf. In some embodiments, the shelf reader contains a reader control board and an array of RF antennae. In some embodiments, each set of antenna creates a defined read zone and the read zones are cycled across the length of the shelf reader electronically. In some embodiments, each smart shelf is connected via USB cable to a control unit which contains a processing unit. The architecture can contain any number of ports in control unit to achieve the desired capacity. Additional features, such as WiFi network connectivity, can be added to the control unit. Each set of shelf readers can be a self-contained network device delivering event based data to the network via the control unit or can connected in series.

In some embodiments, the local read device contains, or is in, a parent-child configuration. In some embodiments, the parent-child configuration contains a parent smart shelf that controls and powers one or more child smart shelves. Such a configuration may reduce cost since it contains a single parent (master) shelf rather than a plurality of parent (master) shelves with their own control and power units.

In some embodiments, the local read device is a smart shelf with an RFID read device and/or a single or plurality of RFID antenna. In some embodiments, the antenna are classified in two groups: short response within the direct confines of the physical shelf and long response whereas the read area extends a distance beyond the physical shelf and with its farthest read edge at a distance from the physical shelf. In some embodiments, the short response antenna are placed in close proximity to one or more products in read area #1. This read area may be made up of multiple antenna or read zones. Within read area #1 products tagged with UHF RFID (wireless detection, RF detection, etc.) are detected for the purpose of detecting an exit event or an entry event. In some embodiments, read area #1 has a closely controlled read zone so as to produce a quick response due to the short distance a picked product travels before it leaves read area #1 upon product exit or entry and having that response be in close proximity to the shelf and the standard merchandising product configuration. Exit events from read area #2 are perceived as taking longer due to the edge of read zone 2 being a distance from the physical shelf.

In some embodiments, the long response antenna produces read area #2 that is also monitoring the shelf but does so with a read field that is either higher in power or leveraging a different type of RF read field, resulting in a stronger and larger read area. Read area #2 is detecting entry events and exit event is a similar fashion to area #1 however read area #2 captures a greater space and therefore has a slower perceived reaction time. Data from Read area #2 is utilized to correct data representing products not presented to, or detected by, read area #1 based on product position or position of multiple products blocking visibility to read area #1.

In some embodiments, the relative size of the read areas are reversed, e.g., read area #1 is larger and read area #2 is smaller as described above.

In some embodiments, the number of read zones is greater than 2 or less than 2, for example, 1, 3, 4, 5, or a greater number of read zones. In some embodiments, the multiple read areas have dual functions in both defined read areas, e.g., short range and long range. In still other embodiments, particular read areas have functions within another read area. In still other embodiments, the multiple read areas intersect and are generated from the same plane.

In some embodiments, data from distinct read areas are combined to provide depth in data or enrich data or generate more accurate data. In some embodiments, data can be reported in an event type fashion to signify if an item is visible in only one of the read areas or in both of the read areas, timing between exits, be governed by different filters or settings or data events within multiple read areas. Data from a plurality of defined read areas may provide depth in data for machine learning, artificial intelligence, localized software and actionable data.

Other sensors and data inputs may also be desirable. These sensors might be non-RF based sensors such as vision, infrared, ultrasonic or other known devices.

### 2. Wide Area Read Devices

In some embodiments, wide-area represents or defines a read zone or multiple read zones that cover the area of the product while at rest as well as the area around where the product is merchandised. In some embodiments, wide-area coverage includes but is not limited to RFID real-times locations systems (RTLS) that report back x and y coordinates. RTLS is typically used pinpoint the exact location of items within a facility. In some embodiments, RTLS works through a combination of Bluetooth technology and GPS in order to monitor and track objects and interactions when they occur. In some embodiments, the RTLS functionality of the RFID reader is used only to complement the existing sensor suite in use.

In some embodiments, the wide area read device is or contains a phased array of overhead readers that work with multiple read zones in a north, south, east, and west configuration. These multiple zones can be used to generate an x and y coordinate. In some embodiments, this RF coordinates are combined with vision coordinates for an item to help provide confirmation after product selection.

### C. Data Paths/Software

In some embodiments, the system receives various formats of data from a plurality of different data sources, repackages the received data for a particular destination, and securely and reliably delivers the packaged digital identity data. Methods and systems for receiving and processing data are described in WO2021/247628, which is incorporated herein by reference.

In some embodiments, the data delivered from the present invention is a set of data or a segment of data from one of a plurality of data sources. These various data sources may be a number of different sensors that collect data based on their particular purpose. The invention anticipates combining data from a single or from a plurality of read areas and combining the multiple data inputs at a repository and/or delivering singular or multiple data sets to machine learning algorithms and/or artificial intelligence systems.

In some embodiments the data delivered from the present invention is combined with other data sources to determine system actions or activity and/or initiate or negate system internal or external notifications.

In some embodiments external sensors collect data that influence the thresholds and events delivered by the present invention

In some embodiments data and/or event data of the present invention influences the thresholds and events delivered by external and/or other sensors.

In some embodiments data sources may cross communicate with each other for the purpose of dynamically adjusting settings within that source device. This method provides dynamic adjustment influenced by the environment as interpreted by other data sources or source devices and sensors.

In some embodiments, the system contains a repository for receiving data about a serialized item from a source. The repository may be a designated application, such as a cloud application, for example, an intermediate software. The serialized item may be a RFID tagged, UPC coded or ERP coded product that contains a digital identity about the product that is readable by the source. The digital identity may contain a product unique identity, an item expiration, or other product related data, and the source of the data may contain an edge device, such as smart shelves, smart coolers, smart stores, or smart storage having a RFID reader/interrogator that has an electronic display and that monitors the products in proximity thereto. For example, when the serialized item is removed from, to, or around the source, the source may communicate that information to the repository.

In some embodiments, the repository may be a designated cloud application, and is preferably configured to receive the data about the serialized item from the source and manage the product's digital identity. The repository may similarly manage a volume of inventory of the product based on the received information from the source, and is further configured to combine or aggregate the received data about the product with other product specific data, environmental specific data, consumer behavior data, or other variable and/or fixed data feeds.

In some embodiments, the system further contains a single or plurality of digital destinations including, but not limited to, cloud application(s). The destination application is configured to receive and publish the combined data sent from the repository via a connector. The connector may be an active directory gateway, cloud connector or the like. The destination application can provide product data, availability, inventory, etc. to searchers in a local area. Additionally, pricing information related to the product may be manipulated by the destination application based on, for example, the product expiration date, shelf life or other data that suits user need and/or preference.

The destination application may then publish the data in a searchable format. Additionally, the destination application can transmit the data back to the source or other electronic display at a retail location, so that the same may benefit from the aggregated and/or updated data. For example, a consumer could view an identical price for the product online at the destination application that they would see at the retail location.

In some embodiments, the methods and systems are as described above and the systems contain a destination cloud application for receiving, manipulating, and publishing data about a serialized item from a source. The serialized item may include, without limitation, a RFID tagged, UPC coded or ERP coded product that contains a digital identity about the product that is readable by the source. The digital identity may include a product unique identity, an item expiration, or other useful product data. The source may be an edge device which can contain a fixed or handheld device for communication with sensors or machine readable code, such as smart shelves, smart coolers, smart stores, or smart storage and having a RFID reader/interrogator that has an electronic display and monitors the products/serialized items located at the source. For example, when a serialized item is removed, added, or manipulated by a customer or staff from, to, or around the source, the source may communicate that information to the destination cloud application.

Similar to the previous embodiment referenced above, the destination cloud application receives the data about the serialized item from the source, and manages the product's digital identity via a connector. The destination cloud application similarly manages a volume of inventory of the product based on the received information from the source. The destination cloud application is configured to combine the received data about the product with other product specific data. The connector may be an active directory gateway, cloud connector or similar device. The destination cloud application can then provide the combined product data or any portion thereof to searchers in a local area. Additionally, pricing information related to the product may be manipulated by the destination cloud application based on, for example, the product expiration date, shelf life or other useful data.

The destination cloud application may then publish the data in a searchable format available to consumers in a local area. Additionally, the destination application or repository can transmit the data back to the source or other electronic display at a retail location, which may also use the combined data. For example, a consumer may view an identical price for the product online at the destination cloud application that they would see at the retail location.

In other embodiments, the methods and systems described herein include processes for increasing migration and accessibility of product related data. The system contains a designated application, such as a cloud application, for receiving data about a serialized item from a source, and the designated application may be an intermediate software. As above, the serialized item may be an RFID tagged, UPC coded or ERP coded product that contains a digital identity about the product that is readable by the source, and the digital identity may contain a product unique identity, an item expiration, or other useful product data or information. The source may be an edge device, such as smart shelves, smart coolers, smart stores, or smart storage with a RFID reader/interrogator that has an electronic display and the ability to monitor the serialized items. For example, when a serialized item is removed from the source, the source may communicate that information to the repository which may, in turn, update the product data stored therein.

The designated application is configured to receive the data about the serialized item from the source, and manage the product's digital identity. The designated application similarly manages a volume of inventory of the product based upon the received information from the source. The designated application is further configured to merge the received data about the product with other product specific data, and may also receive data related to the serialized item from a plurality of data collection points. The plurality of data collection points are sources that do not otherwise lend themselves to a data share atmosphere, such as inventory scans, point of sale data, distributor data, data center data or the like.

The system can further contain a destination application. The destination application is configured to receive, manipulate, and publish the combined data sent from the designated cloud application. The destination application can provide product data, availability, and inventory data to searchers in a local area. Additionally, pricing information related to the product may be manipulated by the destination application based upon the product expiration, shelf life or other data related to the product.

The destination application, e.g., cloud application, then publishes the combined data in a searchable format for consumers in a local area. Additionally, the destination application can transmit the data back to the source or other electronic display at a retail location. A consumer could then view an identical price for the product online at the destination application that they would see at the retail location, and determine if there is local inventory in stock for purchase.

In some embodiments, the methods described herein include or contain edgeware. Edgeware is embedded software that operates in the reader hardware, eliminating the need for on-premises computer equipment and servers. Edgeware simplifies the data path and reduces the software development demands on users. In some embodiments, edgeware delivers event based data, as described above, directly from the reader to local and/or cloud destinations. The event based data is reliable and the software is optimized to reduce stray reads and provide the flexibility to adjust the volume of data delivered from the device to the data destination.

The readers can provide a variety of information. In addition to the unique identifier encoded into or onto the trigger, the reader can provide a time stamp for when an item arrives at a location and/or leaves a location, allowing for calculation of the elapsed time at the location, geographic location, etc. Combinations of the trigger with other sensors, such as those recording/reporting conditions such as temperature, humidity, etc. can provide detailed information for how long an item has been exposed to a particular set of environmental conditions. This can be particularly important for perishable items, particularly fruits and vegetables, proteins, cheeses, etc. and/or other connected products that are susceptible to temperature, humidity, etc.

### D. Geo-Location

The physical location of the connected product can be determined using a variety of techniques in the art. For example, in some embodiments, the device that is used to interrogate or read the digital trigger provides the physical location of the connected product. In some embodiments, the device is a mobile device, such as a smart phone, smartwatches, tablet, laptop, or other hand held devices. In other embodiments, the device is an on premises device such as pallet readers, tunnel readers, gate readers, shelf readers/smart shelfs. In some embodiments, the location of the device is determined using one or more methods or techniques known in the art. Suitable methods and techniques include, but are not limited to, outdoor positioning systems (“OPS”) and indoor positioning systems (“IPS”). Exemplary OPS include, but are not limited to, the global positioning system (“GPS”).

Exemplary IPS include, but are not limited to, non-radio technologies and wireless technologies. Examples of non-radio technologies include, but are not limited to, magnetic positioning, inertial measurements, positioning based on visual markers, and location based on known visual features. Examples of wireless technologies include, but are not limited to, ultra wide band (UWB), WiFi positioning system (WiPS or WFPS), Bluetooth, Bluetooth 5.1, Bluetooth low energy (BLE), choke point concepts, grid concepts, long range sense concepts, angle of arrival, time of arrival, received signal strength indication, and combinations thereof.

In some embodiments, the method or techniques used to determine the location of the mobile device is accurate within 5 meters, 4 meters, 3 meters, 2 meters, 1 meter, 0.9 meters, 0.8 meters, 0.7 meters, 0.6 meters, 0.5 meters, 0.4 meters, 0.3 meters, 0.2 meters, or 0.1 meters.

In some embodiments, the location of the device is determined using one or more techniques described herein and one or more items in close proximity to the device are identified. In some embodiments, the term “close proximity” means within about 10 meters, 9 meters, 8 meters, 7 meters, 6 meters, 5 meters, 4 meters, 3 meters, 2 meters, 1 meter, 0.9 meters, 0.8 meters, 0.7 meters, 0.6 meters, 0.5 meters, 0.4 meters, 0.3 meters, 0.2 meters, or 0.1 meter. However, the item or items may be further away.

The identity of the item or items can be determined using one or more techniques known in the art. Exemplary techniques include, but are not limited to, planograms; visual inventory; RFID handheld inventory; RFID overhead inventory; vision system inventory; QR; barcode; NFC; or other methods known in the art.

In some embodiments, one or more items at the location of the device have attached thereto one or more sensors which can be detected by localized scanners. Such items are said to be digitally identified. The sensors can be incorporated into a label, such as a pressure adhesive label or other type of label, or a tag, such as a hanging tag. The sensor can be any sensor known in the art that is suitable for the methods and applications described herein. In some embodiments, the sensor is, for example, a radio frequency identification (RFID, such as UHF or HF) sensor, a near field communication (NFC) sensor, a quick response (QR) code, machine readable code, vision system, Bluetooth Low Energy (BLE) beacons, or other digital identification (ID) systems. In some embodiments, the location of the device is determined by one or more of the techniques described above and the items in proximity to the mobile device are identified using UHF RFID. In some embodiments, the digital ID system is UHF Gen2 RFID or similar standard.

### E. Identifying Suspicious, Abnormal, Positive, or Negative Events Sequences/Anomalies

The methods described herein may allow a user, such as a manufacturer, retail brand owner, distributor, etc. to see how all of their items (e.g., goods in commerce) are distributed throughout the entire supply chain, for example, from manufacturing site to a retail building, storage location, or retail shelf or floor location, and/or a delivery site, and each site/stop or transit path in between. In some embodiments, the methods include showing the number of items located at each site/stop (e.g., factories, warehouses, stores, etc.) in the supply chain and the number of items that have a suspicious, normal, abnormal, positive, or negative event sequence or anomaly selected as a “callout.” Callouts are identified by comparing actual (including real-time) item-specific or item-level data or parameters to one or more reference data or parameters for that item or a similar item. By comparing the actual data/parameter with the reference data/parameter, the use can determine whether a suspicious, positive, negative, normal event, event sequence has occurred or is occurring. In some embodiments, based on the result, the user or another party can be notified and/or corrective/remedial action can be automatically determined and/or taken as needed.

In some embodiments, locations may be tracked or determined when a digital trigger is interacted with by one or more detecting devices, such as a barcode scanner, a QR code scanner, an NFC reader, an RFID reader, a blue tooth transmitter/receiver, a wifi router or access point, or camera. The detecting device may be integrated into a mobile device such as a smartphone, laptop, or tablet, or a fixed placement device such as a portal scanner, printer, or other device. The detecting device may transfer information to the system that enables determination of a location such as one or more of GPS data, IP address, location according to a planogram or building plan, based on position relative to other devices (e.g., a triangulation or distance measurement), or based on inertial navigation relative to a starting point.

Actions taken by the system based on the callout may include one or more of the following: a notification, a status change, a discard action, a remedy action, a recognition action, a recall action, a price change, or a relocation action. These actions may include one or more of a database status change, an email, text message, route guidance for a person to arrive at the item, instructions on where to move the item, instructions to discard the item, or control of a machine to perform the action. Control of a machine may include automatic transport of the item, such as using a warehouse management systems capable of transporting items. Status changes may allow for data tracking for performance of a retail location or logistics/transportation company and/or may trigger other actions. Discard actions may involve changing a status of an item to discard, meaning that retail or logistics personnel or an automated package handling system may receive instructions to discard an item. Items may be discarded if they are considered expired, they have spoiled, or they have been damaged. Remedy actions may involve providing instructions or taking other physical actions repair, replace, or provide compensation

In some embodiments, a callout may include one or more of the following events in combination and in different sequences.

### 1. Dwell Time

In some embodiments, the callout is a “dwell time” callout. In some embodiments, exemplary “dwell time” callouts include, but are not limited to, when an item spends longer or shorter than expected at a location or series of locations such as one or more supply chain sites, a retail store storage area, a shelf location designated by a store planogram, one or more delivery vehicles. In some embodiments, a dwell time callout includes when an item spends longer or shorter to transit from one location to another (e.g., from one supply chain site to another), or follows an unexpected path, such as during transit from one warehouse to another or during delivery. In some embodiments, the method/system includes a configurable/customizable time variance in order to avoid generating a callout when processing is still within reasonable timeframes. In some embodiments, the reasonable timeframes are established by the end user, e.g., the manufacturer, the retail brand the owner, and/or the retailer.

### 2. Traversal

In some embodiments, the callout results from an unexpected or unusual traverses of the supply chain by the one or more items. Non-limiting examples includes observations that the item is traveling to a site not typically found in the supply chain or the item skips one or more sites typically found in the supply chain or other sequence of locations leading up to and/or including sale or delivery. For example, the item location may be tracked to storage location or to a diversion site that is unexpected, or along a route that is greater than a threshold distance away from an expected route. This skipping of a location or arrival or transit through an unexpected area may be an indication that tampering has occurred, that transportation methods have failed, that a truck driver or airplane pilot is going to the wrong destination, that a product is being shelved or hung or displayed at a non-planogram approved location within a store, or that a customer reshelved a product at the wrong location. For perishable goods or for time sensitive delivery, traversal may result in spoilage. Such misdirection may be a minor problem for an individual item event, but cumulatively may result in significant losses for a manufacturer, shipper, retail store, grocery, or other business.

### 3. Item Status Transition

In some embodiments, the callout is due to a suspicious, unusual, anomalous, normal, positive, or negative event sequence or item status transition, i.e., the order of actions performed on/with an item. In some embodiments, transitions may be monitored by recording when the item arrives at a site, recording when the item moves within the site, recording how and where an item travels along a route during shipment, and/or recording the time the item leaves the site. Events of interest or event sequences may include movement of an item during non-business hours indicating tampering or theft, or rapid acceleration/deceleration indicating a fall and possible damage. A transition callout may relate to longer or shorter times for delivering, storing, stocking, restocking, displaying, or selling an item.

### 4. Connected Product Platform

The methods described herein can be used in combination with a connected products solution or platform, together referred to as a system. An example of such a platform is atma.io provided by Avery Dennison. Atma.io may include a digital trigger-agnostic platform such that any digital trigger(s) known in the art, including combinations of triggers, can provide data to the platform which manages and analyzes the data and provides users insight into their supply chain. In some embodiments, the connected products platform includes a dashboard/hub that allows a user to see all of their items and how they are distributed in the supply chain. In some embodiments, the dashboard/hub includes a card per site type which shows the number of items located at each site type in the supply chain as well as the number of callouts.

The platform/solution can filter and export the data in response to the needs of the end user. For example, the data can be filtered by stock keeping unit (SKU) or by purchase order (PO) number. The data can be exported in any format, e.g., CSV or Excel. The export can be customized to provide any type of information required by the end user, e.g., SKU, PO, quantities, masterdata, etc.

In some embodiments, the platform/solution can also be used to provide trace analytics. In some embodiments, the platform/solution generates callout performance cards, which may identify one or more of the supply chain sites, the product types, the supply types, the transportation modes, the carriers, the individual workers, the workgroup teams, the materials, the suppliers, the factories, the transportation modes, the specific vehicles used within a warehouse, and/or the shipping sites with the fewest, the most, an above or below average or median number of callouts. This may be determined by the number of items related to the callout at a site.

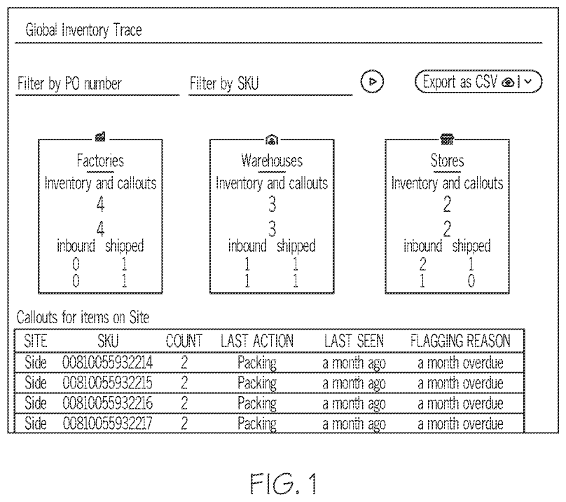

For example, trace analytics may be used to generate performance card for dwell times per site type. In some embodiments, the performance card identifies the sites with the shortest and longest dwell times. In some embodiments, dwell time is expressed as average item dwell time for the site in days. Examples of such performance cards are shown in FIGS. 1-3, which show user interfaces according to some embodiments. Other embodiments for FIGS. 1-3 may include more or less of each feature, and may include other information.

FIG. 1 includes a first filter and a second filter. Filtering options may include filtering by a PO number and/or by an SKU. FIG. 1 further includes a first card, a second card, and a third card, each displaying information relating to a different type of site. For example, the cards of FIG. 1 relate to factories, warehouses, and stores, with callouts and an inventory count for each. In some embodiments, the cards may also display the number of inbound and/or shipped items for one or both of inventory and callouts. In some embodiments, as shown in FIG. 1, the display may identify specific callouts for items on a site. The information shared may include one or more of the site, the SKU, the last action, when last seen, and/or a flagging reason, which may be any one or more of the callouts discussed within this disclosure.

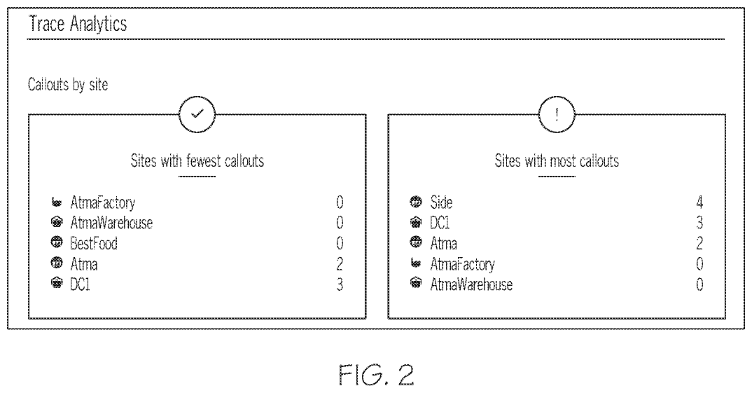

FIG. 2 includes, in accordance with some embodiments, cards listing sites with the fewest callouts or sites with the most callouts. Exemplary locations are disclosed, as well as a number of callouts for those sites. Exemplary sites include factories, warehouses, retail stores, positions within a building or outside a building, and other locations. Other embodiments may include less or more information.

In some embodiments, heuristics and/or machine learning models, e.g., classification and prediction algorithms, are used to analyze the combination of the data described above to identify/predict anomalies. Once an anomaly is identified a callout or alert is provided in the dashboard/hub to allow the customers to inspect the sequence of events and take corrective action as needed.

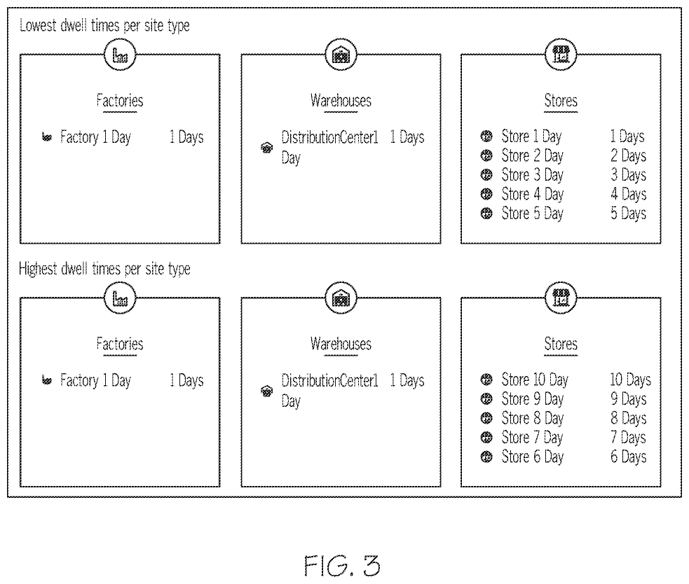

FIG. 3, in accordance with some embodiments, discloses sites with the lowest and highest dwell times per site type and identifies the dwell time for different locations. In some embodiments, a first, second, and third site type are displayed for each category of lowest or highest dwell time.

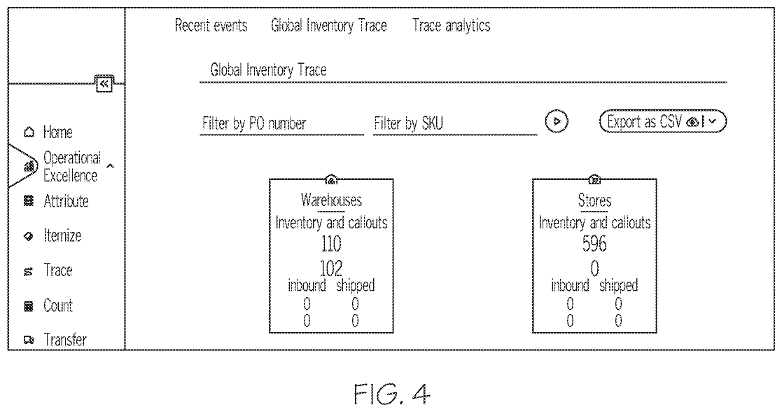

FIG. 4, in accordance with some embodiments, includes options for providing end users with visibility into operations, an option relating to attributes, an option relating to itemizing, an option relating to tracing, an option relating to counting, and an option to transfer.

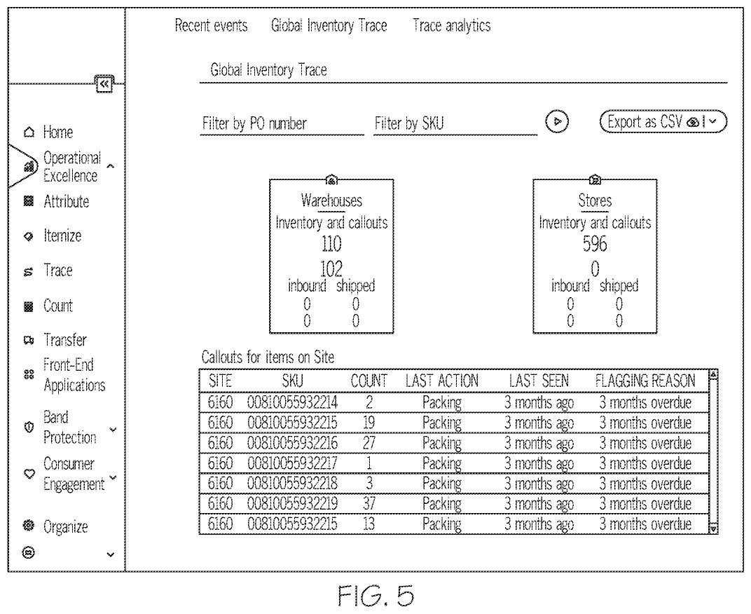

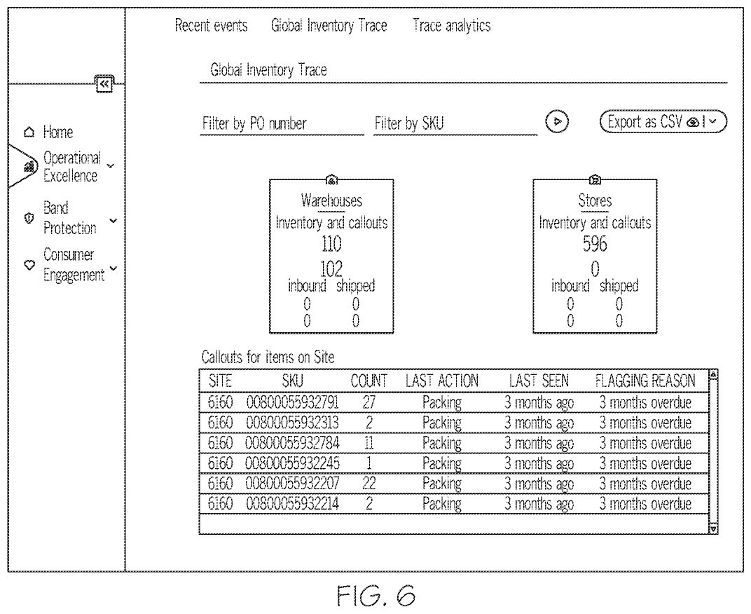

FIG. 5, in accordance with some embodiments, includes options relating to front-end applications, brand protection, and consumer engagement.

### 5. Process Flows

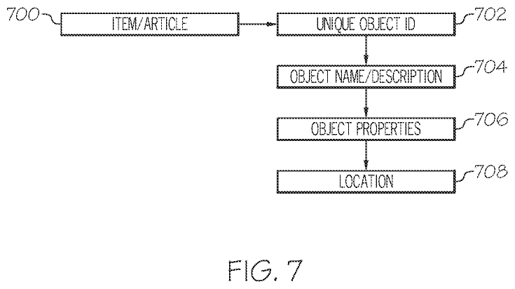

FIG. 7 is a flow diagram showing the assignment of a unique identification number to an item/article and associating data/information/properties that item and its unique ID number in accordance with some embodiments. For example, at the site of manufacture (e.g., for a non-food item) or a packing house, farm, or other site for a food item 700, in operation 702, a tag or label containing a unique digital ID number may be attached to, adhered to, or incorporated into the item or article. The unique digital ID number may be encoded in, embedded in, or associated with one or more digital triggers, such as RFID tags, QR codes, digital watermarks, bar codes, etc. Item-specific information such as size, color, style, item description, pick/package date, manufacturing/packaging location etc. may be associated with the item/article via its unique ID number and that information is stored in the connected product platform/solution. In some embodiments, the unique ID code may be read using a handheld device or on-premises device and the item-specific information in communicated/uploaded to the platform/solution via an API or other application.

For example, in some embodiments, in operation 704, the object name/description is added. In operation 706, object properties are added. In operation 708, a location is associated.

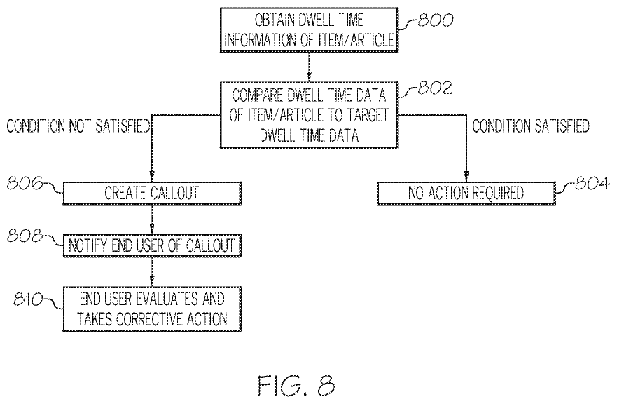

FIG. 8 is a flow chart showing the comparison of dwell time data in accordance with some embodiments. As discussed above, in some embodiments the connected products contain or have attached or adhered there to a digital trigger which provides item-level or item-specific data such as location/sites in the supply chain and dwell times at those sites. The dwell time data for a connected product at a particular site may be compared to reference dwell time data for that item or a similar item. If the dwell time data match or are within acceptable margins of error, then no callout is generated. However, if the data do not agree, the platform/solution generates a callout in the platform. The end user can view the call out to evaluate the significance of the callout and determine whether corrective/remedial actions must be taken. Since most items of commerce are packaged in containers containing dozens, hundreds, or even thousands or more units, unacceptable dwell times can lead to lost revenue, and even financial losses, depending on the nature of the items.

For example, for food items, unacceptable dwell times, particularly under adverse environmental conditions, can significantly decrease shelf-life and it worst case, cause rotting/expiration of the product while still in transit to the retailer. Detection of unacceptable dwell times in this use case can allow intervention, for example, diverting the shipment to a closer warehouse, DC, or retailer in order to get the product on the shelves faster, or if necessary, to determine the product should be discarded or destroyed.

As shown in FIG. 8 and in accordance with some embodiments, in operation 800, dwell time information of an item/article is obtained. In operation 802, the dwell time data of the item/article is compared to a target dwell time data. In various embodiments, the reference dwell time data may be a predetermined number selected as a target (e.g., a reference dwell time), or it may be a historically based variable such as an average, minimum, medium, or maximum dwell time for that specific location, item type, and/or circumstance. The comparison may look for the comparison result to be a match, or within a predetermined threshold range (e.g. 1%, 2%, 4%, 6%, 8%, 10%, 15%, 20%, 25% of the target dwell time) of the target, at least as much as or at most the target dwell time. In operation 804, if the item dwell time satisfies the condition, then no action may be required. In operation 806, if the item dwell time does not satisfy the condition, then a callout is created. In operation 808, an end user is notified of the callout. In operation 810, an end user evaluates and takes corrective action based on the callout.

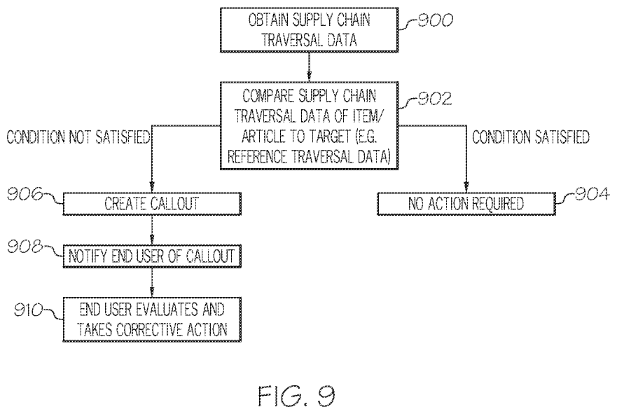

FIG. 9 is flow chart showing the comparison of traversal data in accordance with some embodiments. As discussed above, the connected products may contain or have attached or adhered thereto a digital trigger which provides item-level or item-specific data, such as supply chain traversal data. The traversal data for a connected product may be compared to a target, which may be a reference traversal data for that item or a similar item, such as an expected location, site, position within a store, or a particular supply chain storage/shipping site. If the traversal data satisfy the condition, such as being at or close to the location, or expected to arrive within an acceptable period of time, then no callout is generated. However, if the condition is not satisfied, the platform/solution generates a callout in the platform. The end user can view the callout to evaluate the significance and determine whether corrective/remedial actions must be taken. Since most items of commerce are packaged in containers containing dozens, hundreds, or even thousands or more units, unacceptable traversal events can lead to lost revenue, and even financial losses, depending on the nature of the items.

As shown in FIG. 9 and in accordance with some embodiments, operation 900 includes obtaining supply chain data. In operation 902, the supply chain traversal data is compared to a condition, such as being at or close to an expected location. Close may mean being within a threshold range of feet or miles, or expected to arrive within a threshold number of minutes, hours, days, weeks, or months. In operation 804, if the condition is satisfied, no action is required. In operation 806, if the condition is not satisfied, a callout is created. In operation 808, an end user is notified regarding the callout. In operation 810, an end user evaluates and takes corrective action. In some other embodiments, the system controls a machine to perform a corrective action, such automatically retrieving the item from the incorrect location using a standard warehouse automation and item handling system.

### 6. Sustainability

In addition to the traceability use cases described above, the methods and systems described above can be used to provide information and insights into sustainability. In some embodiments, the platform/solution described herein can be used to manage manufacturing sustainability scores to provide end users, particularly retail brand owners and manufacturers, a 360-degree view of their suppliers. In some embodiments, the callouts described herein can be used to keep track of sustainability assessment expiration dates for manufacturers/suppliers in their supply chain. Each item produced at a specific manufacturing site will inherit the Sustainability Scores valid at the moment in time of production—giving the end user a life-long, immutable record for the conditions under which an item was produced.

Consumers and regulators expect brands to operate in a sustainable manner and companies have made sustainability a centerpiece of their corporate responsibility/good corporate citizen mission. Providing accurate sustainability insights to all stakeholders is a challenge with a dispersed supply chain. Keeping track of assessments and scores across all suppliers, having them available at an item level, and being able to share them with relevant stakeholders and consumers is key in demonstrating sustainability.

### 7. Purchase Order Management

The systems and methods described herein can also be used to automate purchase order management. The systems and methods described herein can create purchase orders, associate ordered items, create and export packing lists, and print carton labels.

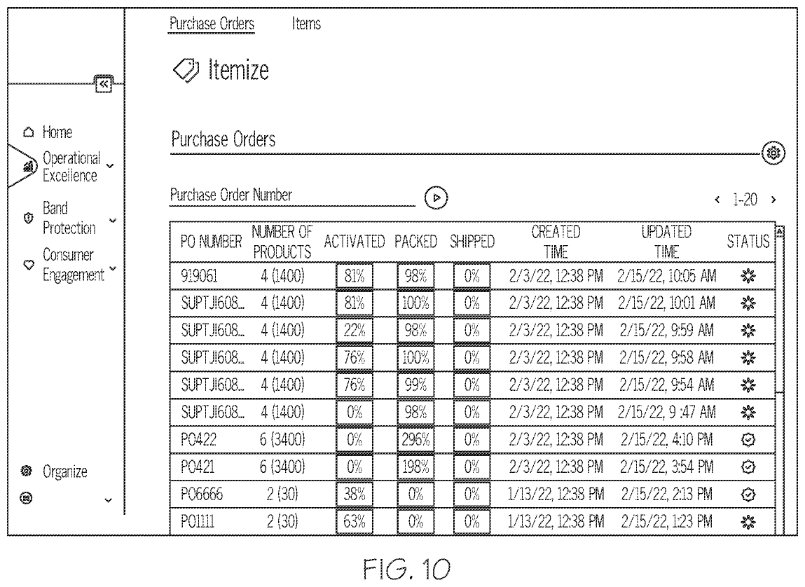

Tracking and managing large purchase orders, registering items on the production line, creating shipping lists, and printing carton labels when done manually require extensive man hours and can be error prone. Keeping the same standards across dozens or even hundreds of manufacturing sites, and ensuring that production is not done through unauthorized subcontractors, creates more complexities and challenges. The platform/solutions described herein can provide a list of all current purchase orders, their states, and the summary of individual items within the purchase orders. A representative example is shown in FIG. 10, which shows one possible embodiment.

By selecting one purchase order from the table, the end user can gain access to its full details. Individual items can be added to the purchase order, be activated, and shipped. There is also an order fulfillment state that keeps track of the progress of a purchase order. Further, the end user can mark it as confirm/complete, which then enables export functionalities. The end user can download various documents like summary packing lists, item-based packing lists, and shipping carton labels.

As discussed, in accordance with some embodiments, FIG. 10 includes one or more of the following: a field for entering a purchase order number, and it discloses data such as a PO number, a number of products (items), a percentage activated, a percentage packed, a percentage shipped, a percentage shipped, a created time, an updated time, and/or a status.

### 8. Consumer Experience

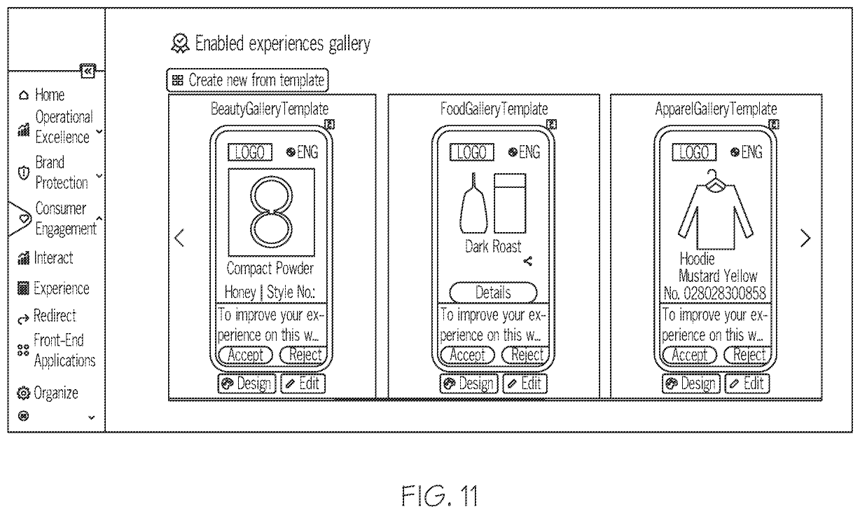

The methods and systems described herein can be used to create a consumer experience, e.g., The Consumer Experience Gallery, examples of some embodiments of which are shown in FIG. 11. The gallery can hold all of the end user's templates and previously used experiences. The end user can browse through to find the needed experience, create a new experience from a template, and customize the designs. Once the experiences are live, the end user can get granular insights into how consumers engage with your products with deeper consumer experience analytics.

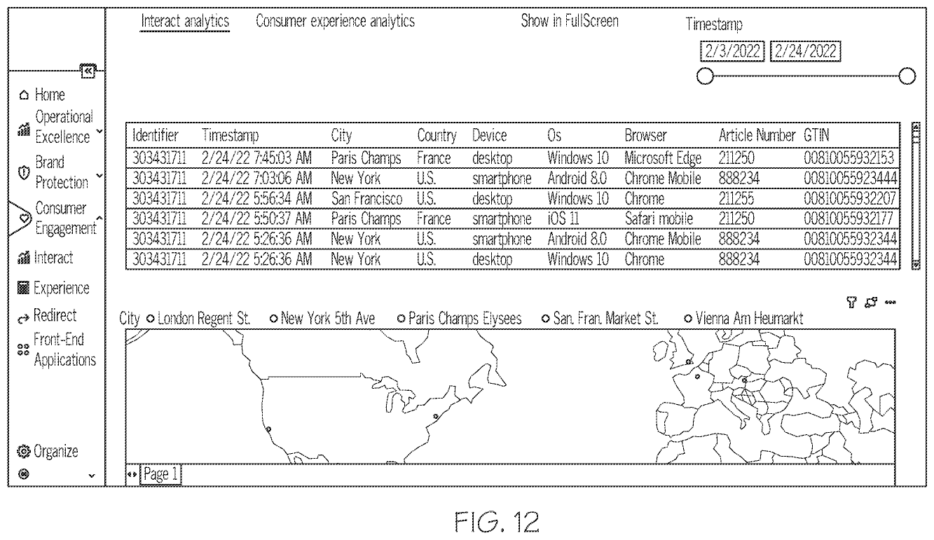

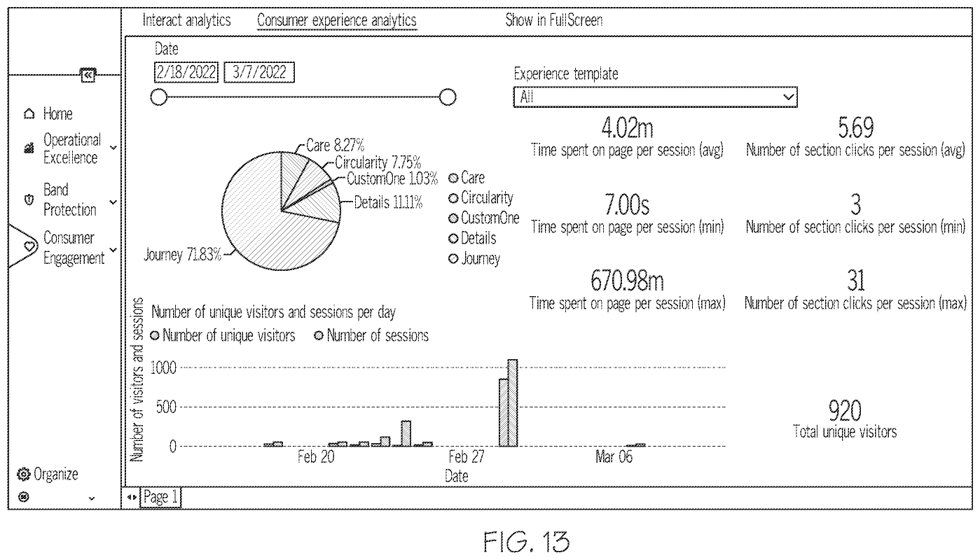

Enabling consumers to directly engage with physical products through unique digital experiences, and communicating with them sustainability credentials with verified data can help deepen the connection between consumers and physical items, as well as gain their loyalty and trust. Evaluating the success of retail brand owner/retailer campaigns based on accurate, empirical data and being able to track how users interact with the experiences enables the RBO/retailer make better and more relevant experiences geared towards their consumers. Exemplary analytics of consumer actions are shown in FIGS. 12 and 13 in accordance with some embodiments.

FIG. 12, in accordance with some embodiments, provides one or more of an identifier, a timestamp, a city, a country, a device name or type, an operating system, a browser identifier, an article number, or a GTIN. Locations on a map may be provided for detection of a digital trigger, such as when a consumer scans a QR code, barcode, or RFID tag. At that point, the digital trigger may route the consumer's device (e.g., a smartphone) to a website associated with an item that the digital trigger is attached to or incorporated into. The system at the same time or at a later date may provide the information shown in FIG. 12 as a result of the consumer's scan of the digital trigger. The end user of the tracking system who receives and views the data in FIG. 12, for example, may be able to view some, all, or other different information related to the consumer's scan of the digital trigger.

Other uses/functionality for the methods and systems described herein include:
1. Count Analytics: provide insight into the state of inventory. For example, how much of each item is at each site may be identified by the system based on current scans, scans through portals as items move past fixed readers, or scans performed manually using handheld readers.
2. Front-end applications may support one or more of a variety of digital triggers, and may be used with one or more of NFC URLs, GS1 digital links, and QR code identifiers;
3. A Consumer Redirect Configuration may provide simplified and easier redirect controls to an end user;
4. Product master data upload functionality may have detailed error handling for improved user experience and attribute schema management for administrators;
5. Reduced complexity for API integration, including administrator-created API keys in the platform/solution, e.g., atma.io;
6. Carton audit reason codes may allow for Advance Shipping Notice support and Transfer analytics over API;
7. Improved support for food industry use cases including reporting metrics that support LOT/batch numbers, as well as expiration dates.

### Exemplary Computer System

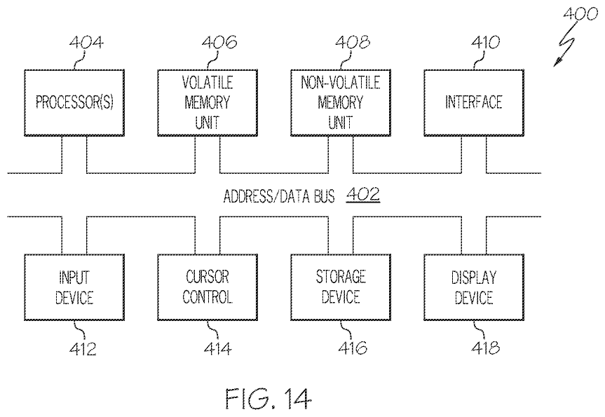

A block diagram depicting an example of a system (i.e., computer system 400) that may be used to process signals and/or perform operations described in this disclosure is provided in FIG. 14. The computer system 400 is configured to perform calculations, processes, operations, and/or functions associated with a program or algorithm. In one aspect, certain processes and steps discussed herein are realized as a series of instructions (e.g., software program) that reside within computer readable memory units and are executed by one or more processors of the computer system 400. When executed, the instructions cause the computer system 400 to perform specific actions and exhibit specific behavior, such as described herein.

The computer system 400 may include an address/data bus 402 that is configured to communicate information. Additionally, one or more data processing units, such as a processor 404 (or processors), are coupled with the address/data bus 402. The processor 404 is configured to process information and instructions. In an aspect, the processor 404 is a microprocessor. Alternatively, the processor 404 may be a different type of processor such as a parallel processor, application-specific integrated circuit (ASIC), programmable logic array (PLA), complex programmable logic device (CPLD), or a field programmable gate array (FPGA).

The computer system 400 is configured to utilize one or more data storage units. The computer system 400 may include a volatile memory unit 406 (e.g., random access memory (“RAM”), static RAM, dynamic RAM, etc.) coupled with the address/data bus 402, wherein a volatile memory unit 406 is configured to store information and instructions for the processor 404. The computer system 400 further may include a non-volatile memory unit 408 (e.g., read-only memory (“ROM”), programmable ROM (“PROM”), erasable programmable ROM (“EPROM”), electrically erasable programmable ROM “EEPROM”), flash memory, etc.) coupled with the address/data bus 402, wherein the non-volatile memory unit 408 is configured to store static information and instructions for the processor 404. Alternatively, the computer system 400 may execute instructions retrieved from an online data storage unit such as in “Cloud” computing. In an aspect, the computer system 400 also may include one or more interfaces, such as an interface 410, coupled with the address/data bus 402. The one or more interfaces are configured to enable the computer system 400 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology.

In one aspect, the computer system 400 may include an input device 412 coupled with the address/data bus 402, wherein the input device 412 is configured to communicate information and command selections to the processor 100. In accordance with one aspect, the input device 412 is an alphanumeric input device, such as a keyboard, that may include alphanumeric and/or function keys. Alternatively, the input device 412 may be an input device other than an alphanumeric input device. In an aspect, the computer system 400 may include a cursor control device 414 coupled with the address/data bus 402, wherein the cursor control device 414 is configured to communicate user input information and/or command selections to the processor 100. In an aspect, the cursor control device 414 is implemented using a device such as a mouse, a track-ball, a track-pad, an optical tracking device, or a touch screen. The foregoing notwithstanding, in an aspect, the cursor control device 414 is directed and/or activated via input from the input device 412, such as in response to the use of special keys and key sequence commands associated with the input device 412. In an alternative aspect, the cursor control device 414 is configured to be directed or guided by voice commands.

In an aspect, the computer system 400 further may include one or more optional computer usable data storage devices, such as a storage device 416, coupled with the address/data bus 402. The storage device 416 is configured to store information and/or computer executable instructions. In one aspect, the storage device 416 is a storage device such as a magnetic or optical disk drive (e.g., hard disk drive (“HDD”), floppy diskette, compact disk read only memory (“CD-ROM”), digital versatile disk (“DVD”)). Pursuant to one aspect, a display device 418 is coupled with the address/data bus 402, wherein the display device 418 is configured to display video and/or graphics. In an aspect, the display device 418 may include a cathode ray tube (“CRT”), liquid crystal display (“LCD”), field emission display (“FED”), Light Emitting Diode (“LED)”, plasma display, or any other display device suitable for displaying video and/or graphic images and alphanumeric characters recognizable to a user.

The computer system 400 presented herein is an example computing environment in accordance with an aspect. However, the non-limiting example of the computer system 400 is not strictly limited to being a computer system. For example, an aspect provides that the computer system 400 represents a type of data processing analysis that may be used in accordance with various aspects described herein. Moreover, other computing systems may also be implemented. Indeed, the spirit and scope of the present technology is not limited to any single data processing environment. Thus, in an aspect, one or more operations of various aspects of the present technology are controlled or implemented using computer-executable instructions, such as program modules, being executed by a computer. In one implementation, such program modules include routines, programs, objects, components and/or data structures that are configured to perform particular tasks or implement particular abstract data types. In addition, an aspect provides that one or more aspects of the present technology are implemented by utilizing one or more distributed computing environments, such as where tasks are performed by remote processing devices that are linked through a communications network, or such as where various program modules are located in both local and remote computer-storage media including memory-storage devices.

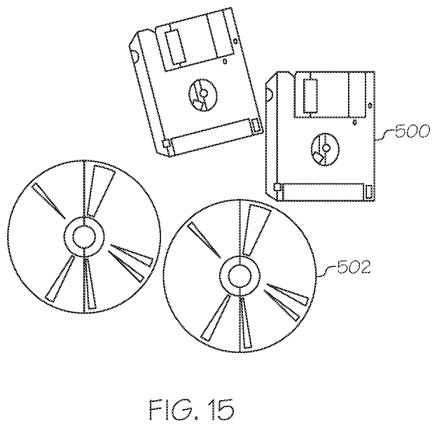

An illustrative diagram of a computer program product (i.e., storage device) is depicted in FIG. 15. The computer program product is depicted as floppy disk 500 or an optical disk 502 such as a CD or DVD. However, as mentioned previously, the computer program product generally represents computer-readable instructions stored on any compatible non-transitory computer-readable medium. The term “instructions” as used with respect to this invention generally indicates a set of operations to be performed on a computer, and may represent pieces of a whole program or individual, separable, software modules. Non-limiting examples of “instruction” include computer program code (source or object code) and “hard-coded” electronics (i.e. computer operations coded into a computer chip). The “instruction” is stored on any non-transitory computer-readable medium, such as in the memory of a computer or on a floppy disk, a CD-ROM, and a flash drive. In either event, the instructions are encoded on a non-transitory computer-readable medium.

It will be understood that the embodiments described above are illustrative of some of the applications of the principles of the present subject matter. Numerous modifications may be made by those skilled in the art without departing from the spirit and scope of the claimed subject matter, including those combinations of features that are individually disclosed or claimed herein. For these reasons, the scope hereof is not limited to the above description but is as set forth in the following claims, and it is understood that claims may be directed to the features hereof, including as combinations of features that are individually disclosed or claimed herein.

1. An processor-based method for identifying or determining a callout event sequence of a connected product at a point or site in a supply chain, the method comprising:
obtaining a real-time parameter of the connected product at a first location within the supply chain by receiving an output from an interrogation of a digital trigger that is attached to or incorporated into the connected product; and
determining a comparison result by comparing the real-time parameter of the connected product with a target parameter using a condition;
based on the comparison result, identifying a related callout; and
based on the callout, remedying the event by performing an automated action;
wherein the callout relates to at least one of dwell time, traversal, and an item status transition; and
wherein the connected product includes a perishable food product.

2. (canceled)

3. The method of claim 1, wherein the callout includes dwell time, and the connected product has been identified as having remained past a threshold time at supply chain site.

4. The method of claim 1, wherein the digital trigger comprises a unique identification number for the connected product and a means for determining the geographical location of the connected product.

5. The method of claim 1, wherein the real-time parameter includes one or more of geographical location, elapsed time at the site, elapsed transit time to or from the site, temperature, humidity, or temperature change.

6. The method of claim 1, wherein the automated action comprises sending an alert based on the callout.

7. The method of claim 1, further comprising ranking the first location against a second location based on the number of callouts created at each location.

8. (canceled)

9. The method of claim 1, wherein the connected product includes a carton, tote, or crate containing additional items.

10. A processor-based system for identifying or determining a callout event sequence of a connected product at a point or site in a supply chain, the system comprising:
a processor; and
a memory,
wherein the processor is configured by instructions contained within the memory to perform
obtaining a real-time parameter of the connected product at a first location within the supply chain by receiving an output from an interrogation of a digital trigger that is attached to or incorporated into the connected product; and
determining a comparison result by comparing the real-time parameter of the connected product with a target parameter using a condition;
based on the comparison result, identifying a related callout; and
based on the callout, remedying the event by performing an automated action;
wherein the callout relates to at least one of dwell time, traversal, and an item status transition; and
wherein the connected product includes a perishable food product.

11. (canceled)

12. The system of claim 10, wherein the callout includes dwell time, and the connected product has been identified as having remained past a threshold time at supply chain site.

13. The system of claim 10, wherein the digital trigger comprises a unique identification number for the connected product and a means for determining the geographical location of the connected product.

14. The system of claim 10, wherein the real-time parameter includes one or more of geographical location, elapsed time at the site, elapsed transit time to or from the site, temperature, humidity, or temperature change.

15. The system of claim 10, wherein the automated action comprises sending an alert based on the callout.

16. The system of claim 10, wherein the system is further configured to perform ranking the first location against a second location based on the number of callouts created at each location.

17. (canceled)

18. The system of claim 10, wherein the connected product includes a carton, tote, or crate containing additional items.
